(19) United States
(12) Patent Application Publication
(10) Pub. No.: US 2026/0288526 A1
(43) Pub. Date: Sep. 24, 2026

(54) Method for processing an electronic message, and associated data processing system

(71) Applicant: ORANGE, ISSY-LES-MOULINEAUX (FR)

(72) Inventor: Thierry GAILLET, CHATILLON CEDEX (FR)

(21) Appl. No.: 19/475,225

(22) PCT Filed: Apr. 11, 2024
(86) PCT No.: PCT/EP2024/059912

§ 371 Date: Oct. 14, 2025

(30) Foreign Application Priority Data
Apr. 17, 2023 (FR) FR2303803

(51) Int. Cl. G06F 9/50; G06K 7/14; G06K 19/06

(52) U.S. Cl. CPC G06F 9/5027; G06K 7/1417; G06K 19/06037

(57) ABSTRACT

A method for processing an electronic message intended for a receiving terminal. The message includes a graphic code encoding data, called “access data”, representative of an access to a computing resource. The method includes: decoding the access data; and generating an interactive object in the electronic message from the decoded access data, the interactive object being configured to provide access to the computing resource when an interaction is carried out with the interactive object.

### CROSS-REFERENCE TO RELATED APPLICATIONS

This Application is a Section 371 National Stage Application of International Application No. PCT/EP2024/059912, filed Apr. 11, 2024, published as WO 2024/217990A1 on Oct. 24, 2024, not in English, which claims priority to French Patent Application No. FR2303803, filed Apr. 17, 2023, the contents of which are incorporated herein by reference in their entireties.

### FILED OF THE DISCLOSURE

The present disclosure belongs to the general field of telecommunications. It more particularly concerns a method for processing an electronic message intended for a receiving terminal, as well as a data processing system configured to implement said method. The disclosure finds a particularly advantageous, although in no way limiting, application in the context of a receiving terminal of the Smartphone type.

### BACKGROUND

The QR code, or quick response code, was developed in the mid-90s and has since seen ever-increasing use, which has in particular accelerated with the massive growth of digital usages particularly those implemented using a Smartphone.

A typical case of use of a QR code is to generate the latter so that it encodes a character string identifying a data resource available on a computer network. For example, this could typically be a QR code encoding a Uniform Resource Identifier (URI) configured to provide access to a computing resource on the Internet network, such as a web page.

In practice, once generated, a traditional use of a QR code consists in displaying the latter using a physical object (wall, door, table, advertising screen, etc.) distinct from a user's Smartphone and equipped with a software application configured to read QR codes. In this way, the user can scan the QR code in question and have access to the corresponding computing resource.

While this conventional approach poses no practical execution issue, it is quite different when a QR code is displayed not via a physical object in the real world distinct from a user's Smartphone, but is on the contrary displayed by the Smartphone itself, for example when the QR code is incorporated in an electronic message, such as an email or a multimedia messaging service still commonly referred to as MMS, and is viewed using the screen of said Smartphone.

Indeed, in this case, it is understood that the Smartphone can no longer be used to scan the QR code contained in the message. Consequently, it is not possible to access the computing resource, which breaks the user experience.

Ultimately, the single current way to address this problem consists, for a user, in having within reach a second equipment (Smartphone, tablet, etc.) that is able to scan and decode the QR code contained in the electronic message displayed on the Smartphone screen. In addition to being expensive, this solution is particularly difficult to implement, so that ultimately the risk that the computing resource will not be consulted is very high.

### SUMMARY

According to a first aspect, the disclosure concerns a method for processing an electronic message intended for a receiving terminal, said message including a graphic code encoding data, called “access data”, representative of an access to a computing resource, said method including steps of:
decoding the access data,
generating an interactive object in the electronic message from the decoded access data, said interactive object being configured to provide access to the computing resource when an interaction is carried out with said interactive object.

For example, the interactive object may be a hyperlink to access the computing resource, the hyperlink being generated so as to be attached to the graphic code and thus make the graphic code clickable to access the computing resource.

Thus, the graphic code contained in the electronic message which, initially, is only an inert image, becomes, thanks to the method according to an aspect of the disclosure, an active image with which it is possible to interact by clicking.

By “clicking”, reference is conventionally made to an interaction that can be direct (i.e., a finger pressure), for example on a touch screen of a Smartphone, or indirect that is to say by means of a device operated by a user, such as a mouse or a stylus.

In other words, the method according to an aspect of the disclosure allows automatically interpreting the graphic code, extracting therefrom the information on the access to the computing resource, and coupling this information with the graphic code.

Thus, a user who consults the electronic message via the receiving terminal no longer needs to have any other equipment to read (scan) the graphic code. This considerably facilitates the accessibility to the data resource, and therefore greatly increases the likelihood that it will be consulted.

Moreover, the fact of not having to have any other equipment advantageously contributes to providing a solution that is inexpensive from the hardware perspective.

It is important to note that the interactive object is not limited to the sole hyperlink intended to be attached to the graphic code. Indeed, it may also be an object of another nature not intended to be attached to the graphic code, but to be incorporated/displayed in the electronic message in addition to the graphic code during the step of generating said other interactive object. By way of non-limiting example, such other interactive object may correspond to a symbol, an icon, an image, a photo, etc. Furthermore, nothing precludes having in the electronic message not only a clickable graphic code as described above but also such other interactive object.

In particular modes of implementation, the processing method may further include one or more of the following characteristics, taken separately or in any technically possible combination.

In particular modes of implementation, the graphic code is any one among: a QR code, a mini QR code, a barcode, a data matrix.

In particular modes of implementation, the access data are representative of a uniform resource identifier configured to provide access to a computing resource on the Internet network.

In particular modes of implementation, said method further includes, before the generation of the interactive object, steps of:
verifying the compliance with a security criterion by the computing resource,
if the verification is not met, emitting an alert message.

These provisions are advantageous insofar as they allow improving the security of access to the computing resource.

For example, the security criterion may be configured to allow verifying that the computing resource is not likely to infect with a virus the receiving terminal of a user who is consulting the electronic message.

Alternatively, the security criterion may be configured to allow verifying that the consultation of the computing resource is not likely to trigger a process for phishing the personal information of the user who is consulting the electronic message.

Generally, no limitation is attached to the nature of the security criterion, the notion of “security” being, within the framework of the present disclosure, characteristic of anything that is free of risks and/or dangers to the integrity of the receiving terminal and/or the user of the receiving terminal. Consequently, no limitation is attached to the manner in which the criterion can be verified (e.g. consultation of a database listing suspicious data resources, making a network diagnosis, for example by means of a ping test of a data resource, etc.).

In particular modes of implementation, said method further includes, following a transmission of the electronic message to the receiving terminal, steps of:
receiving, from the receiving terminal, a notification indicating that an interaction has been carried out with the interactive object,
transmitting the notification to a terminal emitting the electronic message,
redirecting the receiving terminal to the computing resource by using the access data.

In particular modes of implementation, said method further includes, after the generation of the interactive object, a step of transmitting the electronic message to the receiving terminal.

In particular modes of implementation, said method further includes a step of emitting a notification, said notification indicating that the electronic message has been modified following the generation of the interactive object.

In particular modes of implementation, said method further includes, upon receipt of the notification, a step of incrementing a counter and/or timestamping said notification.

The fact of carrying out such an incrementation with a counter advantageously allows establishing statistics relating to the use of services that may be proposed by a service platform when the latter executes all or part of the processing method. The timestamping for its part allows keeping dated proof of the use of the services thus proposed.

Furthermore, the fact of combining an incremental count and a timestamping allows improving the security of the exchanges insofar as it becomes possible to implement intrusion detection tools, such as a distributed denial of service (DDOS) attack.

In particular modes of implementation, the electronic message is an email, a multimedia messaging service, or a message exchanged on an instant messaging platform.

According to a second aspect, the disclosure concerns a computer program including instructions for the implementation of at least the steps of decoding and generating a data processing method according to an aspect of the disclosure when said computer program is executed by a computer.

This program may use any programming language and be in the form of source code, object code, or intermediate code between source code and object code such as in a partially compiled form, or in any other desirable form.

According to a third aspect, the disclosure concerns a computer-readable information or recording medium on which a computer program according to an aspect of the disclosure is recorded.

The information or recording medium may be any entity or device capable of storing the program. For example, the medium may include a storage medium such as a ROM for example a CD-ROM or a microelectronic circuit ROM, or a magnetic recording means for example a hard disk.

On the other hand, the information or recording medium may be a transmissible medium such as an electrical or optical signal, which may be conveyed via an electrical or optical cable, by radio or by other means. The program according to an aspect of the disclosure may particularly be downloaded from an Internet-type network.

Alternatively, the information or recording medium may be an integrated circuit in which the program is incorporated, the circuit being adapted to execute or to be used in the execution of the method in question.

According to a fourth aspect, the disclosure concerns a data processing device including means configured to implement at least the steps of decoding and generating a method for processing an electronic message according to an aspect of the disclosure.

In particular embodiments, the data processing device may further include one or more of the following characteristics, taken individually or in any technically possible combination.

In particular embodiments, said device is integrated into any one among:
a service platform operated by a communication operator,
a messaging platform operated by a messaging operator,
a terminal emitting the electronic message,
a receiving terminal for which the electronic message is intended.

In particular embodiments, the entities operating the service platform and the messaging platform are different or identical.

According to a fifth aspect, the disclosure concerns a data processing system including means configured to implement a data processing method according to an aspect of the disclosure.

In particular embodiments, the data processing system may further include one or more of the following characteristics, taken separately or in any technically possible combination.

In particular embodiments, said system includes a data processing device belonging to a service platform operated by a communications operator, said data processing device being configured to implement all the steps of the processing method.

In particular embodiments, said system includes an emitting terminal, a receiving terminal, a first data processing device belonging to a service platform operated by a communications operator, and/or a second data processing device belonging to a messaging platform operated by a messaging operator, and in which:
the detection, analysis and generation steps are implemented by the second data processing device, or by the emitting terminal, or by the receiving terminal, and
when the method includes steps of verifying and transmitting an alert message, said steps are implemented by the first data processing device or by the second data processing device,
when the method includes steps of receiving a notification indicating that the graphic code has been clicked, of transmitting the notification and of redirecting the receiving terminal, said steps are implemented by the first data processing device or by the second data processing device,
when the method includes a step of transmitting the electronic message to the receiving terminal, said step is implemented by the second data processing device,
when the method includes a step of emitting the notification indicating that the electronic message has been modified, said step is implemented by the second data processing device,
when the method includes an incremention and/or timestamping step, said step is implemented by the first data processing device.

In particular embodiments, the entities operating the service platform and the messaging platform are different or identical.

### BRIEF DESCRIPTION OF THE DRAWINGS

Other characteristics and advantages of the present disclosure will emerge from the description given below, with reference to the appended drawings which illustrate one exemplary embodiment thereof without any limitation. In the figures:

FIG. 1 schematically represents one particular embodiment of a data processing system according to an aspect of the disclosure, said system including a data processing device;

FIG. 2 schematically represents one example of hardware architecture of the data processing device included in the system of FIG. 1;

FIG. 3 represents, in the form of a flowchart, one particular mode of implementation of a communication method, called “general method”, implemented by the system of FIG. 1, said general method encompassing a method for processing an electronic message according to an aspect of the disclosure which is implemented by the device of FIG. 2;

FIG. 4 represents, in the form of a flowchart, another particular mode of implementation of the general method;

FIG. 5 represents, in the form of a flowchart, another particular mode of implementation of the general method;

FIG. 6 represents, in the form of a flowchart, another particular mode of implementation of the general method;

FIG. 7 represents, in the form of a flowchart, another particular mode of implementation of the general method.

### DESCRIPTION OF EMBODIMENTS

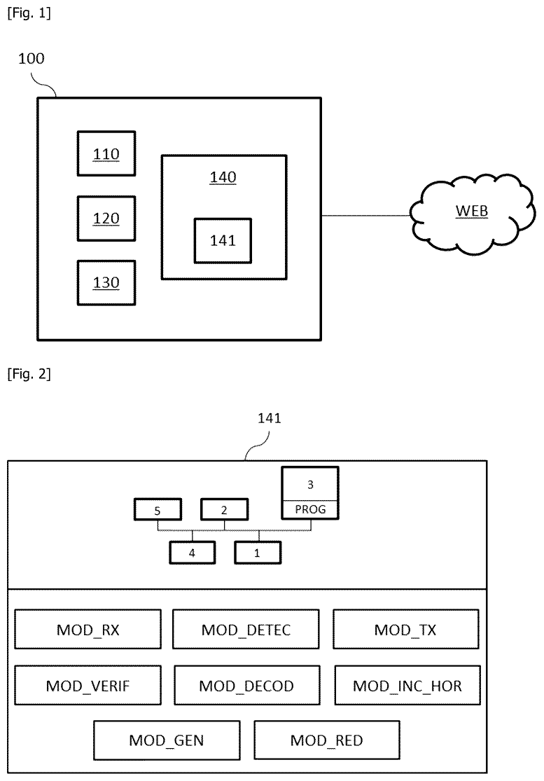

FIG. 1 schematically represents one particular embodiment of a data processing system 100 according to an aspect of the disclosure.

The system 100 of FIG. 1 is configured to carry out processing operations that in particular allow making interactive more particularly clickable, in the present embodiment, a graphic code contained in an electronic message MES emitted by an emitting terminal 110 (sender) and received by a receiving terminal 120 (recipient). It should be noted that in the present embodiment, the two terminals 110, 120 belong to the system 100.

For the remainder of the description, it is considered, in a non-limiting manner, that the emitting 110 and receiving 120 terminals are both Smartphones and that they belong to distinct respective users. It is further considered that the electronic message MES transmitted from the emitting terminal 110 to the receiving terminal 120 is an email. This email was in particular written by the user in possession of the emitting terminal 110, and is intended to be consulted (i.e., read) by the user in possession of the receiving terminal 120.

It should however be noted that these provisions are not limiting the disclosure. Particularly, no limitation is attached to the nature of said emitting 110 and receiving 120 terminals, provided that they are capable of exchanging electronic messages. Thus, nothing precludes envisaging for example that a terminal (emitter/receiver) is a digital tablet, a laptop, a personal assistant, a connected watch, an e-reader, etc.

Similarly, no limitation is attached to the nature of the electronic message MES, provided that it is able to include a graphic code, as detailed below. Thus, nothing precludes envisaging for example a multimedia messaging service of the MMS type, or a message called “instant” message, in other words a message exchanged during an online dialogue (tchat).

In accordance with an aspect of the disclosure, the electronic message MES includes a graphic code encoding data, called “access data” C_CAR, identifying a computing resource. In other words, the access data C_CAR form a link to the corresponding computing resource.

More particularly, in the present embodiment, the graphic code is a QR code and the access data C_CAR are representative of a uniform resource identifier URI configured to provide access to a computing resource on the Internet network (reference “WEB” in the figures), namely here a web page P_WEB.

The fact of considering a graphic code of the QR code type as well as access data C_CAR representative of a resource of the URI type do not constitute limitations of the disclosure, other variants can be envisaged. For example, as regards the graphic code, it can take any form known per se used to convey information, such as for example: a mini QR code, a barcode (e.g. of the PDF147, code 128, etc. type), a data matrix (e.g. of the Flashcode, 2D-doc, datamatrix, etc. type), etc.

As regards the access data C_CAR, these may be for example representative of a URL (Uniform Resource Locator) address, a short URL (tiny URL) address, an address within a local network (e.g., an Internet network within a company, such as an Intranet, so as to identify a file stored on a server of the company), etc. Conventionally, it is understood that the access data C_CAR including one or more character strings allow defining access to the computing resource.

Moreover, if it is considered in the embodiment described here that the computing resource is available on a computer network, nothing precludes envisaging still other alternatives in which the computing resource is available on any one of the entities forming the system 100, such as for example a software application, a photo, a video, etc. stored in a memory of the emitting terminal 110 or of the receiving terminal 120.

The nature of the communication protocol(s) used by the various entities of the system 100 to allow the transmission of the electronic message MES from the emitting terminal 110 to the receiving terminal 120 is in no way limiting the disclosure. Thus, in the present embodiment, at least as regards the terminals 110, 120, any protocol known to those skilled in the art for carrying out data exchanges within the framework of wireless telecommunications can be envisaged (Wi-Fi, 3G, 4G, 5G, etc.). Of course, nothing precludes also envisaging that all or part of the entities of the system 100 communicate by using a protocol adapted to a wired communication network.

As illustrated in FIG. 1, the system 100 includes, in the embodiment described here and in addition to the terminals 110, 120, a messaging platform 130. This messaging platform is configured in hardware and software to allow the management (receipt, sending, redirection, storage, archiving, etc.) of emails, including in particular the electronic message MES.

It should be noted that the embodiment of FIG. 1 is described by considering a single messaging platform 130. These considerations derive from the fact that it is considered here, without limitation and for the sole purpose of simplifying the description, that the email addresses respectively used by the emitting 110 and receiving 120 terminals are hosted and managed at the level of the same messaging platform 130, the latter being operated by a single messaging operator.

That being said, nothing precludes envisaging, following other examples not detailed here, that the system 100 includes two distinct messaging platforms and respectively associated with the two emitting 110 and receiving 120 terminals (e.g. a first messaging platform managed by Google (Gmail) for the emitting terminal 110, and a second messaging platform managed by Orange (Orange mail) for the receiving terminal 120.

In the embodiment described here, the system 100 also includes a data processing device 141 belonging to a service platform 140. By “service platform”, reference is here made to a platform operated by a communication operator (e.g. Orange) to offer data processing services exchanged, in particular, via the messaging platform 130. For this purpose, the device 141 is configured to carry out processing operations that allow in particular making the QR code contained in the message MES interactive (clickable) before the latter reaches the receiving terminal 120, by implementing a method for processing the message MES according to an aspect of the disclosure.

As will also be described below, the fact of considering that the aforementioned processing operations are implemented by the processing device 141 constitutes only one variant of implementation of the disclosure, and nothing precludes envisaging other modes in which all or part of these processing operations are implemented by a device configured appropriately and integrated into the messaging platform 130, the emitting terminal 110 or the receiving terminal 120.

For the remainder of the description, it is considered in a non-limiting manner that the entities respectively operating the service platform 140 and the messaging platform 130 are different. Of course, such provisions are not limiting the disclosure, and nothing precludes envisaging that these entities are identical or that they constitute a single entity (e.g. same commercial company).

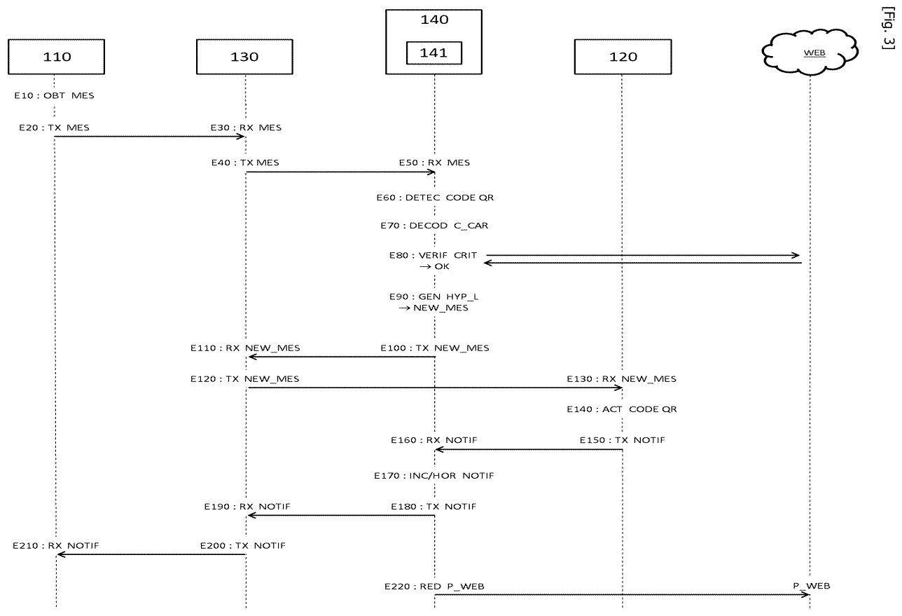

FIG. 2 schematically represents one example of hardware architecture of the data processing device 141 included in the system 100 of FIG. 1.

As illustrated in FIG. 2, the device 141 has the hardware architecture of a computer. Thus, the device 141 includes, in particular, a processor 1, a random access memory 2, a read-only memory 3 and a non-volatile memory 4. It also has communication means 5.

The read-only memory 3 of the device 141 constitutes a recording medium in accordance with an aspect of the disclosure, readable by the processor 1 and on which a computer program PROG in accordance with an aspect of the disclosure is recorded, including instructions for the execution of steps of the processing method. The program PROG defines functional modules of the device 141, which rely on or control the hardware elements 1 to 5 of the device 141 cited above. These functional modules are illustrated in FIG. 1 in a non-limiting manner, and are described in more detail below with reference to different modes of implementation.

The communication means 5 allow the device 141 to exchange (emit/receive) data with one or more other entities of the system 100. For this purpose, and as mentioned above, these communication means 5 rely on a communication interface, which may be wired or non-wired, using any communication protocol known to those skilled in the art.

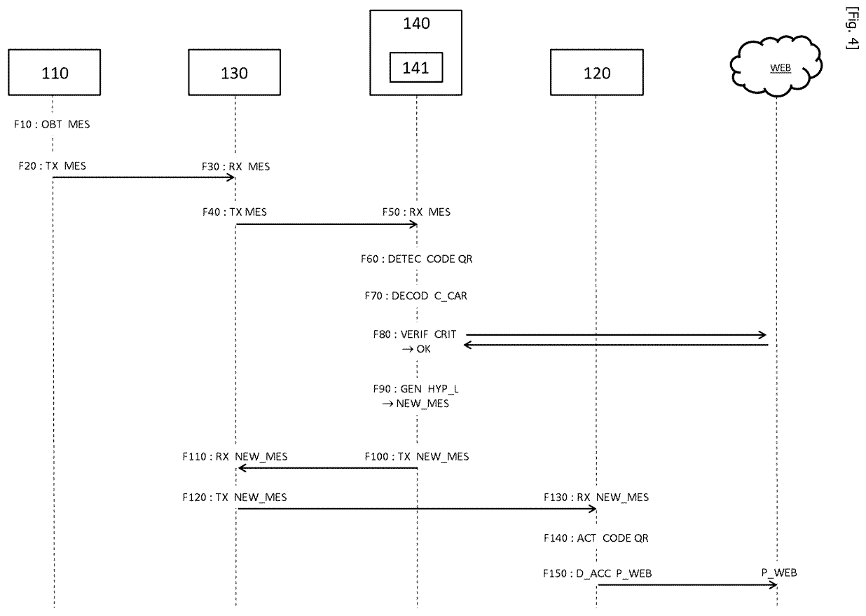

FIG. 3 represents, in the form of a flowchart, one particular mode of implementation of a communication method, called “general method”, implemented by the system 100. Said general method encompasses the method for processing the message MES according to an aspect of the disclosure implemented by the device 141 of FIG. 2.

As illustrated in FIG. 3, the general method initially includes a step E10 of obtaining the message MES. Said step E10 is implemented by the emitting terminal 110.

According to one more particular example of implementation, the obtaining step E10 consists in completely generating the message MES. In other words, according to this example, the user in possession of the emitting terminal 110 generates the message MES by including the QR code therein.

According to another example, the obtaining step E10 firstly includes a receipt of a written message without graphic code, for example coming from a terminal in possession of a user different from the one in possession of the emitting terminal 110, as well as a partial generation of the message MES consisting in incorporating the QR code into the written message.

According to yet another example, the obtaining step E10 includes a receipt of the message MES (i.e. the message already including the QR code), for example coming from a terminal in possession of a user different from the one in possession of the emitting terminal 110. In other words, in this example, the role of the emitting terminal 110 is to carry out a communication relay.

The general method then includes a step E20 of emitting the message MES to the receiving terminal 120. Said step E10 is implemented by the emitting terminal 110.

The message MES emitted is then received by the messaging platform 130 (step E30), and transmitted by the latter (step E40) to the data processing device 141 belonging to the service platform 140.

Upon receipt of the message MES by the device 141 (step E50), the general method includes a step E60 of detecting the QR code in the message MES. Steps E50 and E60 are respectively implemented by a receiving module MOD_RX and a detection module MOD_DETEC equipping the device 141, and are part of the processing method. The transmission module MOD_RX is integrated into the communication means 5 of the device 141.

The detection of the QR code in the message MES is implemented using any technique known to those skilled in the art, in particular by scanning the message MES in order to identify the contours of said QR code.

Once the QR code has been detected, the general method includes a step E70 of decoding the access data C_CAR encoded by the QR code. Said step E70 is implemented by a decoding module MOD_DECOD equipping the device 141 and forms part of the processing method.

It is important to note that the detection E60 and decoding E70 steps are described here separately. That being said, nothing precludes envisaging other modes of implementation in which the decoding of the graphic code admits a broader definition so as to integrate the detection of said graphic code.

In the mode of implementation described here with reference to FIG. 3, the general method also includes a step E80 of verifying the compliance with a security criterion CRIT by the computing resource, i.e. the web page P_WEB, identified by the access data C_CAR. Said step E80 is implemented by a verification module MOD_VERIF equipping the device 141 and forms part of the processing method.

For example, the security criterion CRIT may be configured to allow verifying that the web page P_WEB is not likely to infect the receiving terminal 120 with a virus when it is consulted.

Alternatively, the security criterion CRIT may be configured to allow verifying that the consultation of the web page P_WEB is not likely to trigger a process of phishing personal information of the user in possession of the receiving terminal 120.

Generally, no limitation is attached to the nature of the security criterion CRIT, the notion of “security” being, within the framework of the present disclosure, characteristic of anything that is free of risks and/or dangers to the integrity of the receiving terminal 120 and/or its user. Consequently, no limitation is attached to the manner in which the criterion can be verified (e.g., consultation of a database listing suspicious data resources, making a network diagnosis, for example by means of a ping test of a data resource, etc.).

Therefore, if the verification performed during step E80 is not met (i.e., if the criterion CRIT is not met), the general method may include a step of emitting an alert message (not illustrated in FIG. 3). For example, the alert message may be transmitted to the receiving terminal 120 to warn it not to consult the message MES when the latter reaches it. An alert message may also be transmitted to the operator of the messaging platform 130 to warn it of the potentially fraudulent behavior of the user in possession of the emitting terminal 110.

For the remainder of the description, it is considered that the security verification performed in step E80 is met. It should however be noted that this step E80 (and therefore a fortiori the one consisting in transmitting an alert message if applicable) is optional within the meaning of the present disclosure, and has the advantage of reinforcing the security of the processing of the message MES with respect to the user of the receiving terminal 120.

The general method then includes a step E90 of generating an interactive object in the message MES from the decoded access data C_CAR, said interactive object being configured to provide access to the computing resource when an interaction is carried out with said interactive object. More particularly, in the mode of implementation described here and as illustrated in FIG. 3, the interactive object is a hyperlink HYP_L to access the web page P_WEB, the hyperlink HYP_L being generated so as to be attached to the QR code and thus make the QR code clickable to access the web page P_WEB (in other words, the hyperlink HYP_L is inserted into the QR code). Said step E90 is implemented by a generation module MOD_GEN equipping the device 141 and forms part of the processing method.

In other words, the QR code of the message MES, which was until now an inert image, becomes, via the execution of step E90, an active image with which it is possible to interact by clicking. By “clicking”, reference is conventionally made, in the present embodiment where the receiving terminal 120 is a Smartphone, to a direct interaction (i.e. a finger pressure) on the touch screen of said Smartphone. It should however be noted that the notion of “clicking” can also refer, according to other embodiments, to an indirect interaction, that is to say by means of a device handled by a user, such as for example a mouse or a stylus.

In any event, the fact of attaching the appropriate hyperlink HYP_L to the QR code in the body of the message MES allows, when the latter is received by the receiving terminal 120, greatly facilitating the consultation of the web page P_WEB. Indeed, the user in possession of the receiving terminal 120 can simply click on the QR code, and is no longer required to use other equipment to scan the QR code.

For the remainder of the description, the message containing the QR code to which the hyperlink HYP_L is attached is referred to as “NEW_MES”.

Therefore, and as represented in FIG. 3 without any limitation, the general method includes a step E100 of transmitting the message NEW_MES to the messaging platform 130. Said step E100 is implemented by a transmission module MOD_TX equipping the device 141 and forms part of the processing method. The transmission module MOD_TX is integrated into the communication means 5 of the device 141.

The message NEW_MES emitted is then received by the messaging platform 130 (step E110), and transmitted by the latter (step E120) to the receiving terminal 120 which receives it (step E130).

Therefore, the user in possession of the receiving terminal 120 is able to be directed to the web page P_WEB. To do so, said user clicks on the QR code contained in the message NEW_MES received (step E140 with the reference “ACT CODE QR”).

In the mode of implementation described here, and as illustrated in FIG. 3, the general method includes a step E150 of transmitting a notification NOTIF to the device 141, said notification NOTIF indicating that the QR code has been clicked. Said step E150 is implemented by the receiving terminal 120.

It is noted that insofar as the notification NOTIF is linked to the fact that the QR code is clicked, it then also represents an acknowledgment of receipt of the message initially transmitted by the emitting terminal 110.

Upon receipt of the notification NOTIF by the device 141 (step E160 forming part of the processing method in the present mode of implementation), the general method includes, in the present mode of implementation, a step E170 of incrementing a counter and/or timestamping said notification NOTIF. Said step E170 is implemented by a tracking module MOD_INC_HOR equipping the device 141 and forms part of the processing method.

The incrementation of a counter and/or the timestamping of the notification NOTIF is for example carried out at the level of a database stored and managed by the device 141. Alternatively, step E170 may consist in sending a command to another device (e.g., a dedicated database) of the service platform 140 to carry out said incrementation and/or said timestamping.

It should however be noted that this step E170 is optional within the meaning of the present disclosure, and has various advantages. Indeed, the fact of carrying out such an incrementation with a counter advantageously allows the service platform 140 to establish statistics relating to the use of the services it proposes. The timestamping allows for its part keeping dated proof of the use of services proposed by the service platform 140. Furthermore, the fact of combining an incremental count and a timestamping allows improving the security of the exchanges insofar as it becomes possible to implement intrusion detection tools, such as for example a distributed denial of service (DDOS) attack.

In addition to said incrementation and/or timestamping step E170, said notification NOTIF is transmitted (step E180 forming part of the processing method in the present mode of implementation) to the messaging platform 130 which receives it (step E190) and relays it (step E200) to the emitting terminal 110 which in turn receives it (step E210).

The general method also includes a step E220 of redirecting the receiving terminal 120 to the web page P_WEB by using the URI address associated with the access data C_CAR. Said step E220 is implemented by a redirection module MOD_RED equipping the device 141 and forms part of the processing method.

In other words, in the mode of implementation described here, it is the device 141 that provides the receiving terminal 120 with access to the web page P_WEB.

It should be noted that the redirection step E220 has been described here as being executed after the incrementation and/or timestamping of a counter (step E170) as well as after the notification NOTIF is transmitted from the device 141 to the emitting terminal 110 (steps E180, E190, E200, E210). These provisions are however not limiting the disclosure, the order in which these steps are executed being indifferent.

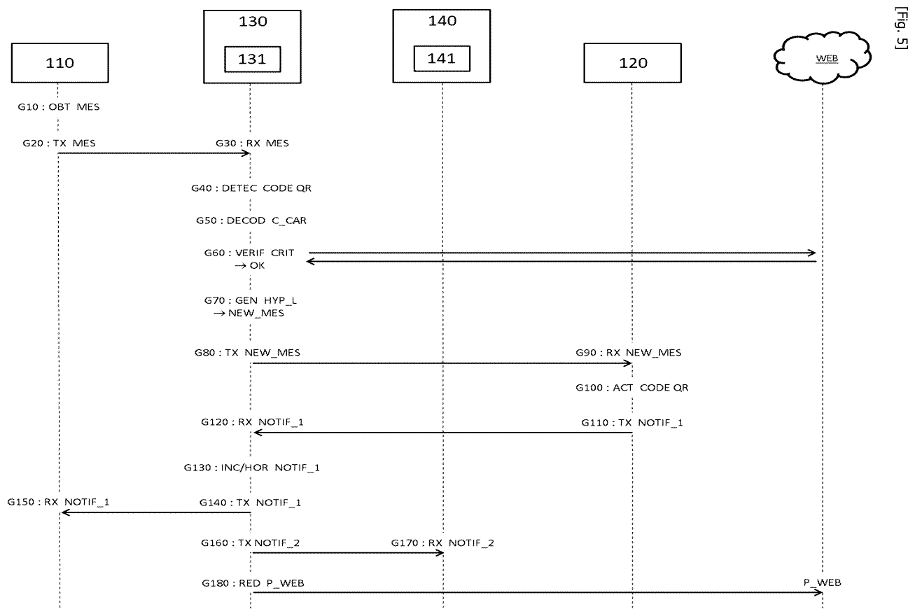

Furthermore, the general method, and therefore ultimately the processing method, has been described up to now by considering an access of the receiving terminal 120 to the web page P_WE via a redirection performed by the device 141 (indirect access). However, nothing precludes envisaging other modes of implementation of the general method in which the receiving terminal 120 directly accesses the web page P_WEB as soon as the QR code has been clicked. Such other mode of implementation is illustrated in a non-limiting manner in FIG. 4, in which steps F10 to F140 are identical to steps E10 to E140. Moreover, as can be seen in FIG. 4, the general method then includes a step F150 of directly accessing (reference “D_ACC CODE QR”) the web page P_WEB by the receiving terminal 120 following the fact that the QR code of the message NEW_MES is clicked. Furthermore, in this mode of implementation of FIG. 4, no notification NOTIF is transmitted by the receiving terminal 120. Of course, according to an alternative to this mode of implementation, a notification NOTIF can be transmitted by the receiving terminal 120, as described with reference to FIG. 3, while allowing direct access to the web page P_WEB.

Generally, the disclosure has been described so far by considering that all the steps of the processing method are implemented by the data processing device 141 of the service platform 140. That being said, the disclosure still covers other embodiments which are now described.

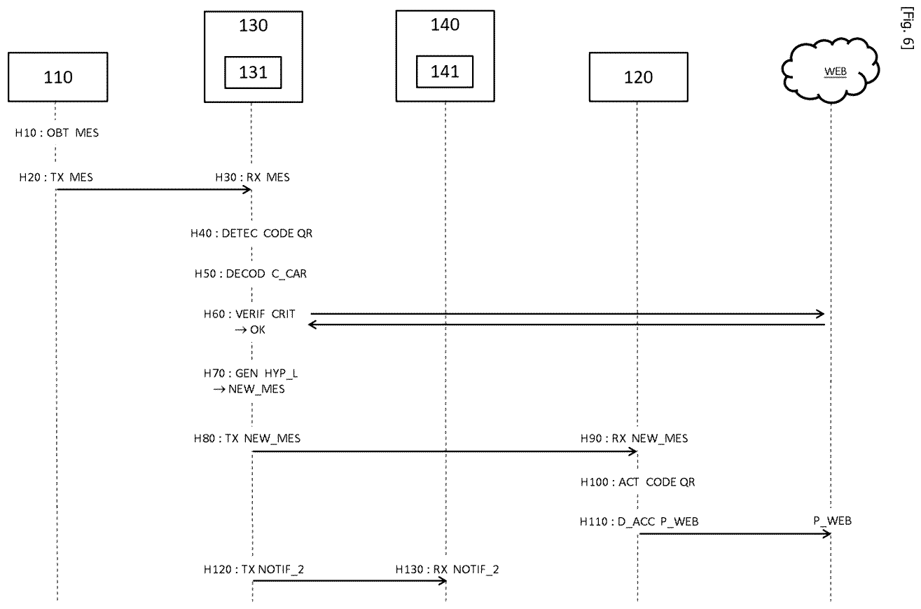

FIG. 5 represents, in the form of a flowchart, another particular mode of implementation of the general method.

In this other mode of implementation, it is considered that the messaging platform 130 includes a data processing device 131, called “second data processing device 131”, configured in hardware and software according to technical provisions similar to those described above with reference to FIG. 2 for the data processing device 141, called here “first data processing device 141”, and belonging to the services platform 140.

As can be seen in FIG. 5, once the message MES has been obtained by the emitting terminal 110 (step G10), it is transmitted (step G20) to the second device 131 which receives it (step G30). The second device 131 detects the QR code (step G40), decodes the access data C_CAR (step G50), verifies the security criterion CRIT (step G60), generates the hyperlink HYP_L (step G70), and then transmits (step G80) the message NEW_MES to the receiving terminal 120 which receives it (step G90).

The user clicks on the QR code of the message NEW_MES (step G100), which triggers the sending to the second device 131 of a first notification NOTIF_1 indicating that the QR code has been clicked (step G110). The second device 131 receives the first notification NOTIF_1 (step G120) and increments a counter and/or timestamps said first notification NOTIF_1 (step G130). In the manner described for step E170 of FIG. 4, it should be noted that said step G130 is optional, and can further be implemented by the first device 141 rather than by the second device 131.

The first notification NOTIF_1 is then transmitted (step G140) to the emitting terminal 110 which receives it (step G150). Moreover, and as illustrated in a non-limiting manner in FIG. 5, the second device 131 emits a second notification NOTIF_2 (step G160), said second notification NOTIF_2 indicating that the electronic message MES has been modified by attaching the hyperlink HYP_L to the QR code (i.e. following the generation of the hyperlink HYP_L as an interactive object). This second notification NOTIF_2 is emitted by the second device 131 to the first device 141 which receives it (step G170) for example, to store it. Such a second notification NOTIF_2 allows for example supervising (monitoring) the number of times where messages containing graphic codes are modified via the attachment of hyperlinks to these graphic codes.

Finally, the second device 131 redirects the receiving terminal 120 to the web page P_WEB by using the URI address associated with the access data C_CAR (step G180).

It should be noted that the emission of the second notification NOTIF_2 has been described here as being performed after the receipt of the first notification NOTIF_1 by the emitting terminal 110. This is however not a limitation of the disclosure, as the second notification NOTIF_2 can be emitted at any time once step G70 of generating the hyperlink HYP_L has been executed. Moreover, the emission of the second notification NOTIF_2 is also optional within the meaning of the present disclosure.

It is also noted that the mode of FIG. 5 has been described by considering that the detection G40, decoding G50, verification G60 and generation G70 steps are implemented by the second device 131. However, nothing precludes envisaging that only part of these steps is implemented by the second device 131, the other remaining steps being for their part implemented by the first device 141. For example, the verification step G60 can be implemented by the first device 141.

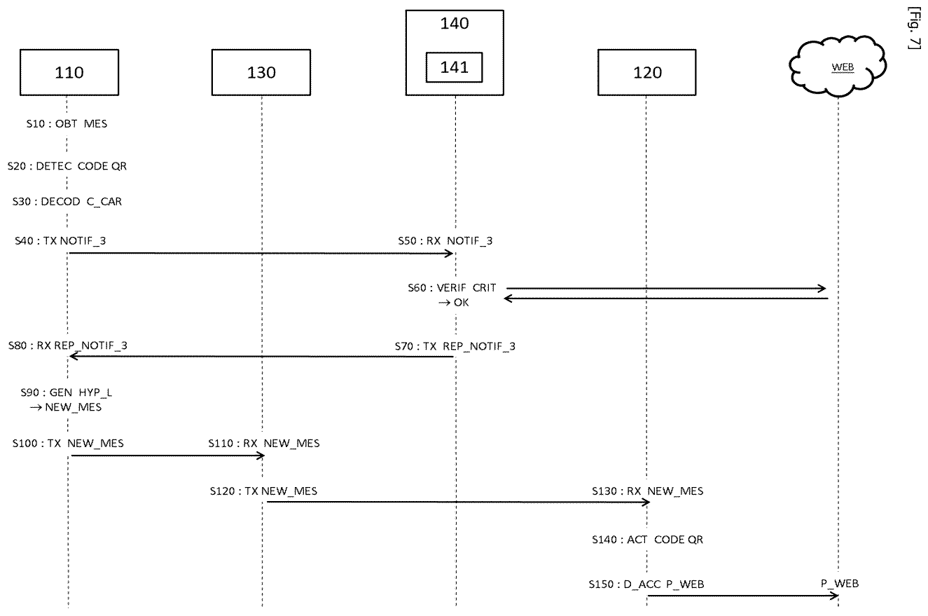

FIG. 6 represents, in the form of a flowchart, yet another particular mode of implementation of the general method. In the mode of FIG. 6, steps H10 to H100 are identical to steps G10 to G100. Moreover, as can be seen in FIG. 6, the general method then includes a step H110 of directly accessing (reference “D_ACC CODE QR”) the web page P_WEB by the receiving terminal 120 following the fact that the QR code of the message NEW_MES is clicked. Furthermore, in this mode of implementation of FIG. 6, the first notification NOTIF_1 is not emitted by the receiving terminal 120, unlike the second notification NOTIF_2 which is emitted by the second device 131 (step H120) and received by the first device 141 (step H130).

The modes of FIGS. 3 to 6 have been written by considering that the steps of detecting, decoding, verifying and generating the hyperlink are implemented by a data processing device of the service platform and/or a data processing device of the messaging platform. That being said, still other modes can be envisaged in which at least part of these steps (in particular the steps of detecting, decoding and generating the hyperlink) are implemented by the emitting terminal 110 or the receiving terminal 120, for example by means of a software application whose code instructions are stored in a memory of the corresponding terminal.

Such other mode is for example illustrated in a non-limiting manner in FIG. 7, in which the detection (step S20), the decoding (step S30) and the generation (step S90) of the hyperlink HYP_L are implemented by the emitting terminal 110. The verification of the criterion CRIT (step S60) is for its part performed by the device 141 of the service platform 140 upon receipt (step S50) of a notification NOTIF_3 emitted by the emitting terminal 110 (step S40) to request said verification, and it being understood that the device 141 emits a response REP_NOTIF_3 to this request (step S70) once the verification has been performed. Of course, it is possible to envisage an alternative in which the verification of the criterion CRIT is carried out by the messaging platform 130 (i.e. by an appropriate processing device integrated into the messaging platform 130).

It is moreover understood that a mode of implementation similar to that of FIG. 7 can still be envisaged on the receiving terminal 120 side with regard to at least the detection, decoding and generation of the hyperlink HYP_L. This other mode of implementation is not described here in detail, as those skilled in the art are able to carry it out based on all the technical considerations described so far.

Moreover, in the embodiments described above, it has been considered that the generated interactive object is a hyperlink attached to the graphic code so as to make the latter clickable. That being said, within the meaning of the present disclosure, the interactive object is not limited to the sole hyperlink intended to be attached to the graphic code. Indeed, it may also be an object of another nature not intended to be attached to the graphic code, but to be incorporated/displayed in the electronic message in addition to the graphic code during the step of generating said other interactive object. By way of non-limiting example, such other interactive object may correspond to a symbol, an icon, an image, a photo, etc. Furthermore, nothing precludes having in the electronic message not only a clickable graphic code as described above but also such other interactive object.

An exemplary aspect of the present disclosure overcomes all or part of the drawbacks of the prior art, in particular those set out above, by proposing a solution that allows accessing a computing resource identified by a graphic code contained in an electronic message more efficiently than the solutions of the state of the art.

Although the present disclosure has been described with reference to one or more examples, workers skilled in the art will recognize that changes may be made in form and detail without departing from the scope of the disclosure and/or the appended claims.

1. A method comprising:
processing an electronic message intended for a receiving terminal, said message including a graphic code encoding data, called “access data”, representative of an access to a computing resource, said processing being performed by a data processing device and comprising:
decoding the access data; and
generating an interactive object in the electronic message from the decoded access data, said interactive object being configured to provide access to the computing resource when an interaction is carried out with said interactive object.

2. The method of claim 1, wherein the interactive object is a hyperlink to access the computing resource, the hyperlink being generated so as to be attached to the graphic code and thus make the graphic code clickable to access the computing resource.

3. The method of claim 1, wherein the graphic code is any one among: a QR code, a mini QR code, a barcode, or a data matrix.

4. The method of claim 1, wherein the access data are representative of a uniform resource identifier configured to provide access to a computing resource on the Internet network.

5. The method of claim 1, said method further including, before generating the interactive object:
verifying compliance with a security criterion by the computing resource; and
in response to the verification being not met, emitting an alert message.

6. The method of claim 1, said method further including, following a transmission of the electronic message to the receiving terminal:
receiving, from the receiving terminal, a notification indicating that an interaction has been carried out with the interactive object;
transmitting the notification to a terminal emitting the electronic message,
redirecting the receiving terminal to the computing resource by using the access data.

7. The method of claim 1, said method further including, after generating the interactive object, transmitting the electronic message to the receiving terminal.

8. The method of claim 7, said method further including emitting a notification, said notification indicating that the electronic message has been modified following generating the interactive object.

9. The method of claim 6, said method further including, upon receipt of the notification, incrementing a counter and/or timestamping said notification.

10. The method of claim 1, wherein the electronic message is an email, a multimedia messaging service, or a message exchanged on an instant messaging platform.

11. A non-transitory storage medium comprising a computer program stored thereon including instructions for implementing the method of claim 1 when said program is executed by a computer of the data processing device.

12. (canceled)

13. A data processing device comprising:
at least one processor; and
at least one non-transitory computer readable medium comprising instructions stored thereon which when executed by the at least one processor configure the data processing device to process an electronic message intended for a receiving terminal, said message including a graphic code encoding data, called “access data”, representative of an access to a computing resource, said processing comprising:
decoding the access data; and
generating an interactive object in the electronic message from the decoded access data, said interactive object being configured to provide access to the computing resource when an interaction is carried out with said interactive object.

14. data processing device of claim 13, said device being integrated into any one among:
a service platform operated by a communications operator,
a messaging platform operated by a messaging operator,
a terminal emitting the electronic message,
the receiving terminal for which the electronic message is intended.

15. The device of claim 14, wherein entities operating the service platform and the messaging platform are different or identical.
